(19) United States
(12) Patent Application Publication
(10) Pub. No.: US 2021/0058261 A1
(43) Pub. Date: Feb. 25, 2021

(54) CONFERENCE ASSISTANCE SYSTEM AND CONFERENCE ASSISTANCE METHOD

(71) Applicant: HITACHI, LTD., Tokyo (JP)

(72) Inventor: Takuya Fujioka, Tokyo (JP)

(73) Assignee: HITACHI, LTD., Tokyo (JP)

(21) Appl. No.: 16/815,074

(22) Filed: Mar. 11, 2020

(30) Foreign Application Priority Data
Aug. 23, 2019 (JP) 2019-152897

(51) Int. Cl. H04L 12/18; G10L 17/00; G10L 17/22

(52) U.S. Cl. CPC H04L 12/1822; G10L 17/22; G10L 17/005

(57) ABSTRACT

A speech of a conference participant is efficiently facilitated. A conference assist system indicates a score to recommend a speech to participants in a conference based on information inputted from an interface.

### TECHNICAL FIELD

The present invention relates to a technology of assisting a conference.

### BACKGROUND OF THE INVENTION

In recent years, some devices are proposed to facilitate a conference to make the conference more efficient by sensing a state of the conference with the voices in the conference. Such devices are called a conference assistance device. Japanese Unexamined Patent Application Publication No. 2011-223092 discloses an example of such devices. In Japanese Unexamined Patent Application Publication No. 2011-223092, in teleconferencing using a network, to provide speaking opportunities to all conference participants, a next speaking recommendation value is automatically determined from voice input histories of the participants and durations of no voice. In response to the value, a speaking voice volume is adjusted.

### SUMMARY OF THE INVENTION

It is difficult to know a timing of speaking in a conference. Particularly when a conference is teleconferencing, when social standings, positions, and views are different among participants, or when participants do not know each other well, difficulty increases. In the past technology, it is difficult to know a suitable speaking timing. Additionally, it is difficult to consider willingness of a participant to speak.

It is thus desirable to efficiently facilitate speeches of conference participants.

A preferable aspect of the present invention includes a conference assistance system that indicates a score to recommend a speech of a participant in a conference based on information inputted from an interface.

Another preferable aspect of the present invention includes a conference assistance method executed by an information processing device. Based on information inputted from an interface, a score is calculated to recommend a speech of a participant in a conference.

As a further specific section, at least one of a voice and image of a current speaker is inputted. Based on at least one of the voice and image of the current speaker, alertness of the current speaker is estimated. Based on the alertness, a first timing score is estimated.

As a further specific section, speech recommendations from other participants are inputted. Based on a total of the speech recommendations from other participants, a second timing score is estimated. Each of values of the speech recommendations from other participants decreases as time passes since each speech recommendation is made.

As a further specific section, a text of speech content of a current speaker and a text of a past speech of a score calculation subject are inputted. Based on a relationship between the speech content of the current speaker and the past speech of the score calculation subject, a third timing score is estimated.

Speeches of conference participants can be efficiently facilitated.

### BRIEF DESCRIPTION OF THE DRAWINGS

FIG. 1 is a block diagram showing an example of a hardware configuration of a conference assistance device in an embodiment;

FIG. 2 is an image about an example of use of an embodiment;

FIG. 3 is a functional block diagram showing operation of a conference assistance device in a first embodiment;

FIG. 4 is an image of a display example of an image outputted on a personal terminal in an embodiment;

FIG. 5A is a functional block diagram showing operation of a conference assistance device in a second embodiment;

FIG. 5B is a graph showing a principle of a speech recommendation in the second embodiment;

FIG. 5C is a graph showing weighting of a speech recommendation in the second embodiment;

FIG. 6 is a functional block diagram showing operation of a conference assistance device in a third embodiment;

FIG. 7 is a functional block diagram showing operation of a conference assistance device in a fourth embodiment;

FIG. 8 is a block diagram showing an example of a hardware configuration of a conference assistance device in a fifth embodiment;

FIG. 9 is a functional block diagram showing operation of the conference assistance device in the fifth embodiment;

FIG. 10 is a block diagram showing an example of a hardware configuration of a conference assistance device in a sixth embodiment; and

FIG. 11 is a functional block diagram showing operation of the conference assistance device in the sixth embodiment.

### DETAILED DESCRIPTION

Hereafter, embodiments are described using the drawings. The present invention is not limited to the descriptions of the following embodiments. Without departing from the spirit and scope of the present invention, modification of a specific configuration of the invention can be easily understood by the persons skilled in the art.

In after described configurations of the invention, the same parts or the parts having a similar function use the same reference sign through different drawings. The duplicative description may be omitted.

Multiple components having the same or similar function may use the same reference sign having a different suffix. When the multiple components do not need to be distinguished, the suffix may be omitted.

The descriptions “first,” “second,” and “third” are attached to identify components and does not necessarily limit the number, order, or contents of the components. Numbers to identify components are used in each context. A certain number used in a context does not necessarily indicate the same component in another context. A component identified by a certain number is not prevented from having a function of a component identified by another number.

An actual position, size, shape, and range of each component in the drawings may not be described to facilitate the understanding of the invention. Therefore, the present invention is not necessarily limited to the positions, sizes, shapes, ranges disclosed in the drawings.

The publications, patents, and patent applications quoted in this specification form part of the explanation of this specification without change.

The components expressed in a singular form in this specification include a plural form unless clearly indicated in a specific context.

An example of a system explained in the following embodiments is as follows. A score indicating whether a current timing is appropriate as a speech timing is indicated to conference participants individually or simultaneously. This score is called a speech timing score. This score is calculated from any one, two, or three of alertness of a current speaker, recommendations from other participants, and a relationship between a speech of a current speaker and a past speech of a score calculation subject. The score is indicated to participants as a current speech timing score.

With such a system, conference participants can know an appropriate speech timing. Additionally, a speech opportunity can be efficiently provided to a participant who hesitates to speak.

### First Embodiment

In the first embodiment, a speech timing score of each participant is calculated from alertness estimated from a voice and face image of a current speaker. The speech timing score is then presented. In this embodiment, when the alertness of a speaker is not high, the speech timing score is calculated to be high, for example.

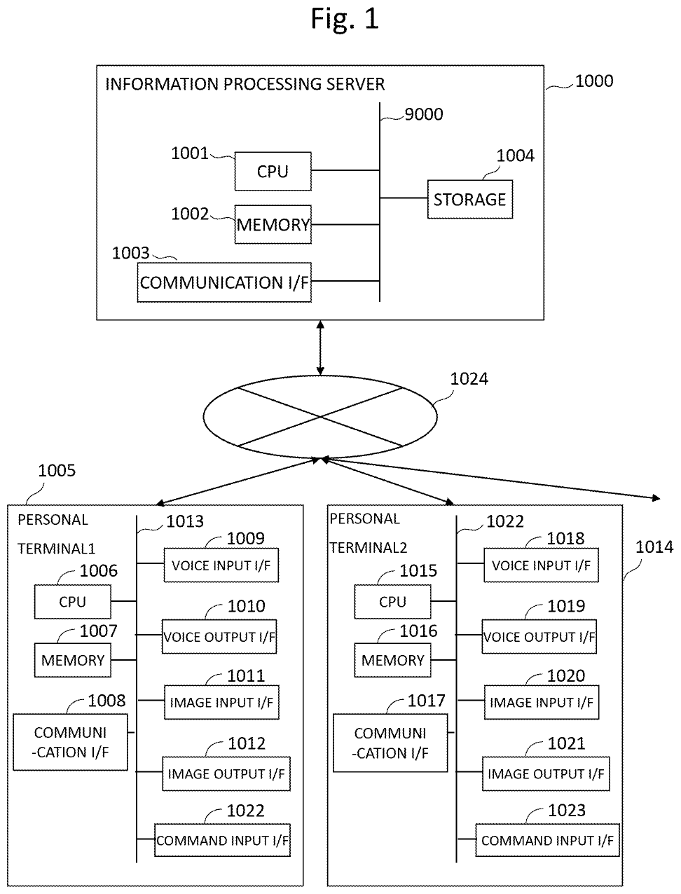

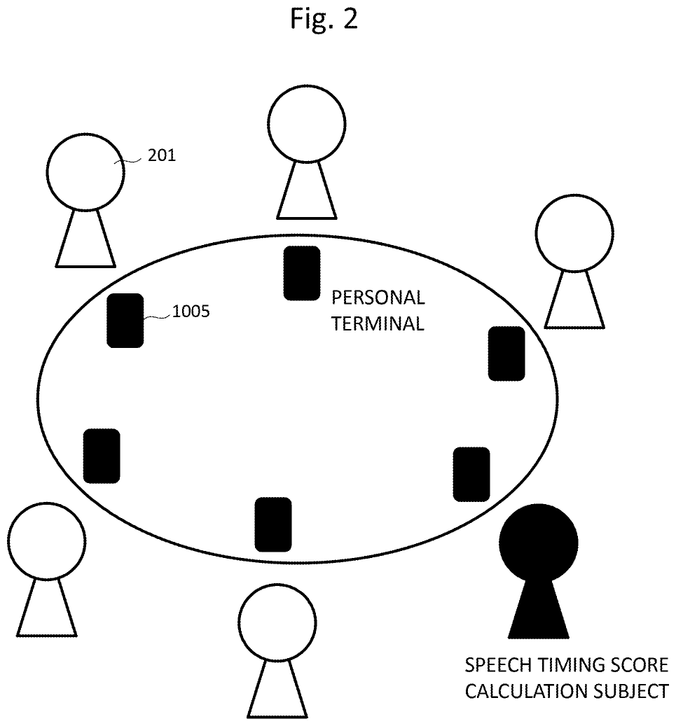

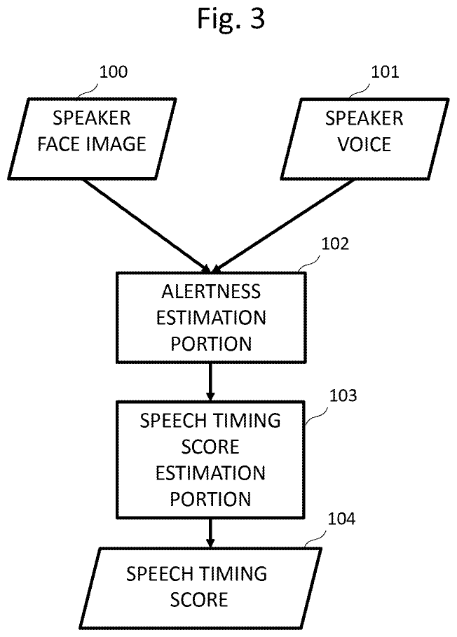

Hereafter, with reference to FIGS. 1, 2, and 3, a configuration and operation of a conference assistance device of this embodiment are explained. FIG. 1 is a block diagram showing an example of a configuration of hardware in this embodiment. FIG. 2 is an image about an example of use of this embodiment. FIG. 3 is a block diagram showing operation of the conference assistance device in this embodiment.

FIG. 1 shows an example of a hardware configuration of this embodiment. In the configuration of FIG. 1, an information processing server 1000 is connected to multiple personal terminals 1005, 1014 via a network 1024. The information processing server 1000 has a CPU 1001, a memory 1002, a communication I/F 1003, and a storage 1004. These components are connected to each other by a bus 9000. The personal terminal 1005 includes a CPU 1006, a memory 1007, a communication I/F 1008, a voice input I/F 1009, a voice output I/F 1010, an image input I/F 1011, and an image output I/F 1012. These components are connected to each other by a bus 1013. The personal terminal 1014 includes a CPU 1015, a memory 1016, a communication I/F 1017, a voice input I/F 1018, a voice output I/F 1019, an image input I/F 1020, and an image output I/F 1021. These components are connected to each other by a bus 1022. The information processing server 1000 may be absent. Multiple information processing servers 1000 may be present.

FIG. 2 shows an image about an example of use of this embodiment. FIG. 2 shows multiple participants 201 who are conducting a conference in which each participant 201 has a personal terminal 1005. In the first embodiment, a speech timing score of each participant 201 is calculated, and displayed on each personal terminal 1005. Only a personal speech timing score or speech timing scores of all participants may be displayed. The scores of all participants may be displayed on a display that multiple participants can see, instead of a personal display. As a system, only a specific participant such as a chairperson may see scores of all participants.

FIG. 3 illustrates processing in the memory 1002 in the information processing server 1000 or in the memory 1007 in the personal terminal 1005 and the memory 1016 in the personal terminal 1014 in FIG. 1 in this embodiment.

The functions such as calculations and controls are achieved when the CPUs 1001, 1006, and 1015 execute programs stored in the memories 1002, 1007, and 1016 in cooperation with other hardware. A program, a function of the program, or a section of achieving the function may be called a “function,” “section,” “portion,” “unit,” or “module”.

The flow of FIG. 3 includes an alertness estimation portion 102 and a speech timing score estimation portion 103. Either or both of a speaker face image 100 and a speaker voice 101 are inputted to the alertness estimation portion 102. The speaker face image 100 is acquired from the image input I/F 1011 in the personal terminal 1005 of a current speaker or from the image input I/F 1020 in the personal terminal 1014 of a current speaker. The speaker voice 101 is acquired from the voice input I/F 1009 in the personal terminal 1005 of a current speaker or from the voice input I/F 1018 in the personal terminal 1014 of a current speaker.

The alertness estimation portion 102 estimates alertness through a mechanical learning model based on either or both of the inputted speaker face image 100 and speaker voice 101 or through a rule-based model based on a feature value such as an amplitude or speech speed of the speaker voice 101. The alertness can be used as an evaluation index about how a speaker is excited or emotional.

The alertness estimated in the alertness estimation portion 102 is inputted into the speech timing score estimation portion 103. A speech timing score 104 is outputted from the speech timing score estimation portion 103. The speech timing score 104 is defined as a function in inverse proportion to alertness. For example, the timing score is low when a speaker is excited, and the timing score is high when a speaker is calm. Speaking may be thus easy when the timing score is high. The speech timing score 104 outputted from the speech timing score estimation portion 103 is displayed on the image output I/F 1012 in the personal terminal 1005 in FIG. 1 and the image output I/F 1021 in the personal terminal 1014 in FIG. 1 or on a separately prepared display.

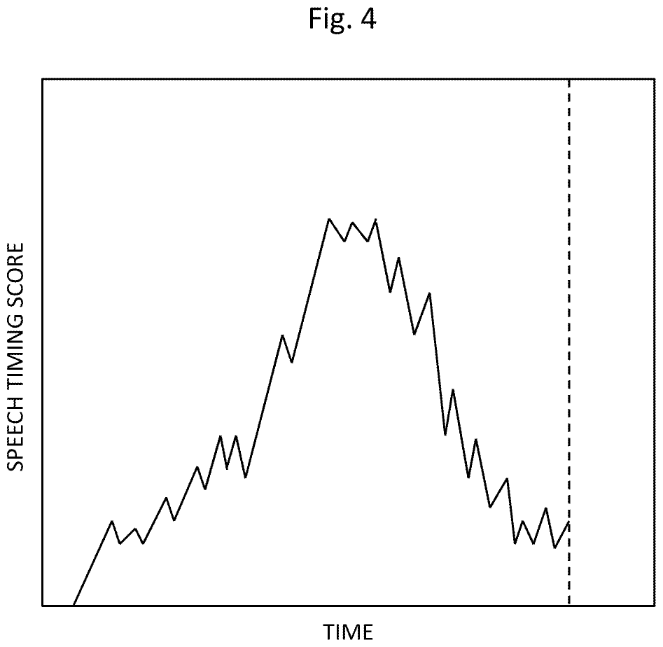

FIG. 4 shows a display example of the speech timing score 104 displayed on the image output I/F 1012 in the personal terminal 1005 in FIG. 1 and the image output I/F 1021 in the personal terminal 1014 in FIG. 1 or on a separately prepared display. The horizontal axis indicates a time and the vertical axis indicates a speech timing score. The time shown by the dotted line indicates a current time. The speech timing score may be displayed as a value estimated in the speech timing score estimation portion 103 of FIG. 3 without change. The speech timing score may be displayed as a value normalized using a maximum value or average value from a start of a conference to a current time.

As above, in this embodiment, a speech timing score of each participant is calculated from alertness of a current speaker. For example, when a high social status participant or an influential participant participates in a conference, this embodiment is effective to make other participants easily speak.

A feature value estimated from a voice and face image of a current speaker includes alertness in this embodiment. The feature value may include other emotions of the current speaker.

Based on at least one of properties of a speaker and participants, a speech timing score may be weighted. For example, when a status of a current speaker is high, a speech timing score is low. When a status of a participant (speech timing score calculation subject) is high, a speech timing score is high. Such information may be acquired from an unillustrated personnel database.

### Second Embodiment

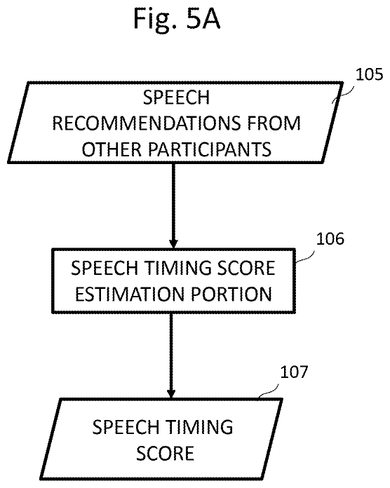

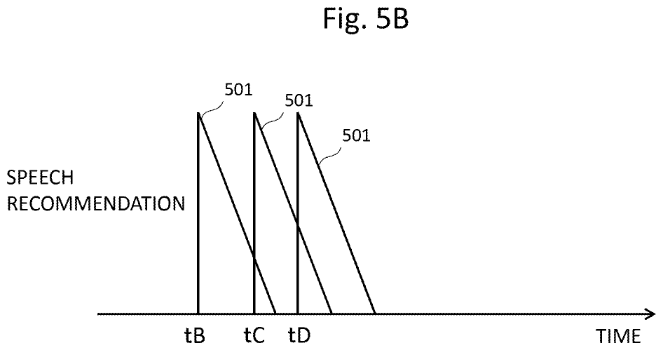

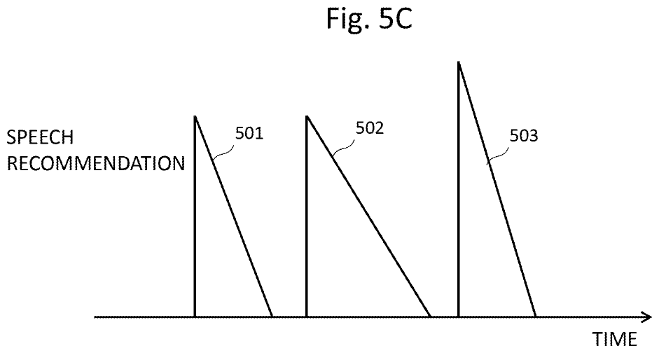

In the second embodiment, a speech timing score of each participant is calculated from recommendations from other participants, and presented. Any participants can recommend speeches of any other participants by using the personal terminals 1005, 1014 at any timings. A speech recommendation is inputted, for example, from the command input I/F 1022 in the personal terminal 1005 of FIG. 1 and the command input I/F 1023 in the personal terminal 1014 of FIG. 1. When many speech recommendations for a speech timing score estimation subject are made, the speech timing score is high. Hereafter, with reference to FIGS. 5A and 5B, a configuration and operation of a conference assistance device of this embodiment are explained.

FIG. 5A is a block diagram showing operation of the conference assistance device in this embodiment. The hardware configuration in this embodiment is the same as that of the first embodiment as in FIG. 1. The example of use of this embodiment is the same as that of the first embodiment as in FIG. 2.

FIG. 5A shows processing in the memory 1002 in the information processing server 1000 or in the memory 1007 in the personal terminal 1005 and the memory 1016 in the personal terminal 1014 in FIG. 1 in this embodiment. This flow includes the speech timing score estimation portion 106. Speech recommendations 105 from other participants are inputted into the speech timing score estimation portion. The speech recommendations 105 from other participants are acquired from the command input I/F 1022 in the personal terminal 1005 and from the command input I/F 1023 in the personal terminal 1014 in FIG. 1. The speech timing score estimation portion 106 calculates a speech timing score Sₜ at a time t based on the following equation.

$${S}_{t} = {{\sum }^{t}}_{τ = 1} f ( τ ) {r}_{τ} \qquad [ Equation 1 ]$$

In Equation 1, γτ is a total value of speech recommendations for a speech timing score calculation subject, and f(τ) is zero in τ>t, maximum in τ=t, and monotonically decreases as τ decreases.

A speech timing score 107 outputted from the speech timing score estimation portion is displayed on the image output I/F 1012 in the personal terminal 1005 and on the image output I/F 1021 in the personal terminal 1014 in FIG. 1 or on a separately prepared display.

FIG. 5B illustrates a calculation principle of a speech timing score for a certain participant A. The horizontal axis shows a time. Three participants B, C, and D execute the speech recommendations 501 for the participant A at timings tB, tC, and tD. Each speech recommendation 501 decreases in value as time elapses. The total value of the speech recommendations 501 is a speech timing score for the participant A at the elapsed time.

The method of displaying the speech timing score is the same as that of the first embodiment. As above, in this embodiment, a speech timing score of each participant is calculated from recommendations from other participants. This embodiment is effective, for example, in a conference in which free thinking is expected.

FIG. 5C shows another example of the speech recommendations. Also in this embodiment, the speech recommendations can be weighted. For example, when the recommender C is influential, a reduction rate of, e.g., a speech recommendation 502 may be moderated. An initial value of, e.g., a speech recommendation 503 may be weighted. The speech recommendation may be weighted based on a relationship between a speech recommender and a speech recommended person. For example, when the participant B is a superior of the participant A, the speech recommendation from the participant B is weighted greater like the speech recommendations 502 and 503.

### Third Embodiment

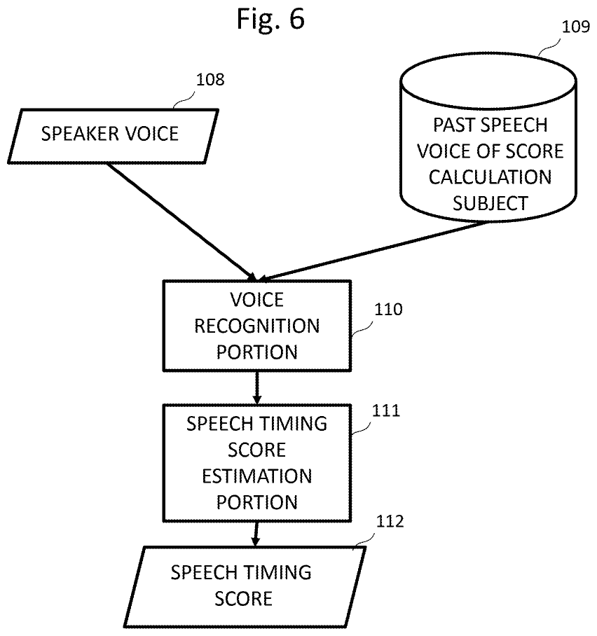

In the third embodiment, a speech timing score of each participant is calculated from a relationship between a speech of a current speaker and a past speech of a score calculation subject, and presented. Hereafter, with reference to FIG. 6, a configuration and operation of a conference assistance device of this embodiment are explained.

FIG. 6 is a block diagram showing operation of a conference assistance device in this embodiment. The hardware configuration in this embodiment is the same as that of the first embodiment and the second embodiment as in FIG. 1. An example of use of this embodiment is the same as that of the first embodiment as in FIG. 2.

FIG. 6 illustrates processing in this embodiment in the memory 1002 in the information processing server 1000 or in the memory 1007 in the personal terminal 1005 and the memory 1016 in the personal terminal 1014 in FIG. 1. This flow includes a voice recognition portion 110 and a speech timing score estimation portion 111.

A speech 108 of a current speaker and a past speech voice 109 of a score calculation subject are input to the voice recognition portion 110. The voice recognition portion 110 estimates a speech text of the speech 108 of the current speaker and a speech text of the past speech voice 109 of the score calculation subject through a known speech recognition technique. The estimated speech texts are inputted into the speech timing score estimation portion 111.

The speech timing score estimation portion 111 estimates a speech timing score 112 based on a relationship between the speech text estimated from the speech 108 of the current speaker and the speech text estimated from the past speech voice 109 of the score calculation subject. An example of the estimation may include a function to acquire a high score when the relevance between both texts is high.

The speech timing score estimation portion 111 can use, for example, a machine learning model with a teacher. Alternatively, the texts are subjected to vector transformation. Then, based on the number of occurrences or frequency of the same or similar words or on the contextual similarity, the estimation is made.

The pooled past speech voices 109 of a score calculation subject are inputted into the voice recognition portion 110 in this figure. The speech text data estimated from the past speech voices 109 of the score calculation subject through the speech recognition may be pooled. The speech 108 of the current speaker may be transformed to text by a different system and inputted from an interface. The method of displaying a speech timing score is the same as that of the first embodiment and the second embodiment.

As above in this embodiment, a speech timing score of each participant is calculated from a relationship between a speech of a current speaker and a past speech of a score calculation subject. This embodiment is effective, for example, when a speech of a participant who has knowledge about or is interested in a current topic is to be facilitated.

### Fourth Embodiment

In the fourth embodiment, a speech timing score of each participant is calculated from a combination of two or more of three elements including alertness of a current speaker, recommendations from other participants, and a relationship between a speech of the current speaker and a past speech of a score calculation subject, and presented.

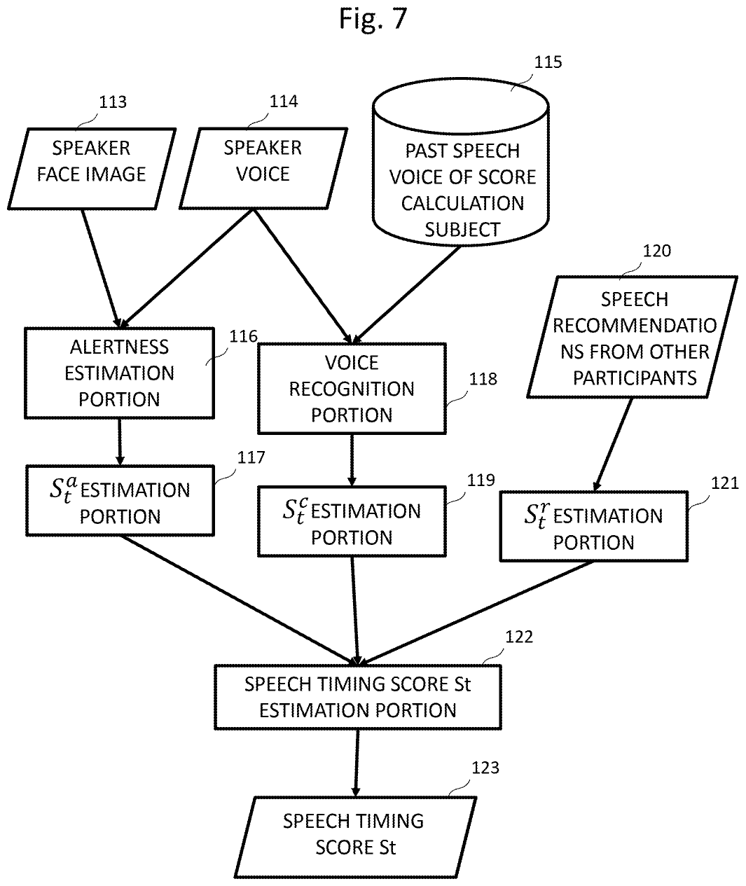

With reference to FIG. 7, a configuration and operation of a conference assistance device of this embodiment are explained. FIG. 7 is a block diagram showing operation of the conference assistance device in this embodiment.

The hardware configuration in this embodiment is the same as that of the first to third embodiments as in FIG. 1. The example of use of this embodiment is the same as that of the first to third embodiments as in FIG. 2.

In this embodiment, FIG. 7 illustrates processing in the memory 1002 in the information processing server 1000 or in the memory 1007 in the personal terminal 1005 and the memory 1016 in the personal terminal 1014 in FIG. 1. This flow includes an alertness estimation portion 116, an S^{a}ₜ estimation portion 117, a voice recognition portion 118, an S^{c}ₜ estimation portion 119, an S^{r}ₜ estimation portion 121, and a speech timing score Sₜ estimation portion 122.

Either or both of a speaker face image 113 and a speaker voice 114 are inputted into the alertness estimation portion 116. As in the first embodiment, alertness is estimated through a mechanical leaning model based on either or both of the speaker face image 113 and speaker voice 114 or through a rule-based model based on a feature value such as an amplitude or speech speed of the speaker voice 101.

The alertness estimated in the alertness estimation portion 116 is inputted into the S^{a}ₜ estimation portion 117. The S^{a}ₜ estimation portion 117 outputs a speech timing score S^{a}ₜ based on the alertness. As in the first embodiment, S^{a}ₜ is defined as a function in inverse proportion to the alertness.

As in the third embodiment, the speaker voice 114 and past speech voice 115 of a score calculation subject are inputted into the voice recognition portion 118. The voice recognition portion 118 estimates each speech text of the speaker voice 114 and past speech voice 115 of a score calculation subject through a known speech recognition technique. The estimated speech text is inputted into the S^{c}ₜ estimation portion 119. As in the third embodiment, the S^{c}ₜ estimation portion 119 estimates S^{c}ₜ based on a relationship between a speech text estimated from the speaker voice 114 and a speech text estimated from the past speech voice 115 of a score calculation subject. An estimation example may include a function to acquire a high score when a relevance between both texts is high. In this figure, as in the third embodiment, the pooled past speech voice 115 of a score calculation subject are inputted to the voice recognition portion 118. The speech text data estimated from the past speech voice 115 of the score calculation subject by speech recognition may be pooled.

Speech recommendations 120 from other participants are inputted into the S^{r}ₜ estimation portion 121 as in the second embodiment. The speech recommendations 120 from other participants are acquired from the command input I/F 1022 in the personal terminal 1005 in FIG. 1 and from the command input I/F 1023 in the personal terminal 1014 in FIG. 1. The S^{r}ₜ estimation portion 121 calculates S^{r}ₜ at the time t based on the following equation.

$${S}_{t}^{r} = {{\sum }^{t}}_{τ = 1} f ( τ ) {r}_{τ} \qquad [ Equation 2 ]$$

In equation 2, γτ is a total value of speech recommendations for a speech timing score calculation subject at a time τ, and f(τ) is 0 in τ>t, maximum in τ=t, and monotonically decreases as τ decreases.

To the speech timing score Sₜ estimation portion 122, S^{a}ₜ estimated in the S^{a}ₜ estimation portion 117, S^{c}ₜ estimated in the S^{c}ₜ estimation portion 119, and S^{r}ₜ estimated in the S^{r}ₜ estimation portion 121 are inputted. The speech timing score Sₜ is then outputted. The speech timing score Sₜ estimation portion 122 calculates the speech timing score Sₜ based on the following equation.

Sₜ=w^{a}S^{a}ₜ+w^{r}S^{r}ₜ+w^{c}S^{c}ₜ

In this equation, w^{a}, w^{r}, and w^{c} are any weights and adjusted to adjust contributions of S^{a}ₜ, S^{r}ₜ, and S^{c}ₜ to Sₜ. The values of w^{a}, w^{r}, and w^{c} are desirably changed based on a feature of a conference. Some preset patterns can be prepared.

Some examples of the preset patterns are described. The first pattern is such that a higher social status person and a lower social status person participate in a conference. To think about the higher social status person in this case, the value of w^{a} is set higher than w^{r} and w^{c}. In this case, the value of w^{a} can also be automatically increased only during a speech of a specific speaker.

The second pattern is such that a conference requires free thinking. In this case, to emphasize speech recommendations from other participants, the value of w^{r} is set higher than w^{a} and w^{c}. The third pattern is such that similar social status persons participate in a conference. In this case, to emphasize context of the conference, the value of w^{c} is set higher than w^{a} and w^{r}. Before or during a conference, a user (for example, chairperson) may choose a feature of the conference from the preset patterns or the values of w^{a}, w^{r}, and w^{c} may be specifically specified.

### Fifth Embodiment

The fifth embodiment provides a simpler system than the first to fourth embodiments. Through any one of the methods of the first to fourth embodiments, the speech timing scores Sₜ of all participants are calculated. When the speech timing scores Sₜ of all the participants are a predetermined threshold or less, a signal illuminates to indicate that “any participants now have an appropriate speech timing” in devices referenceable by all the participants or a specific participant.

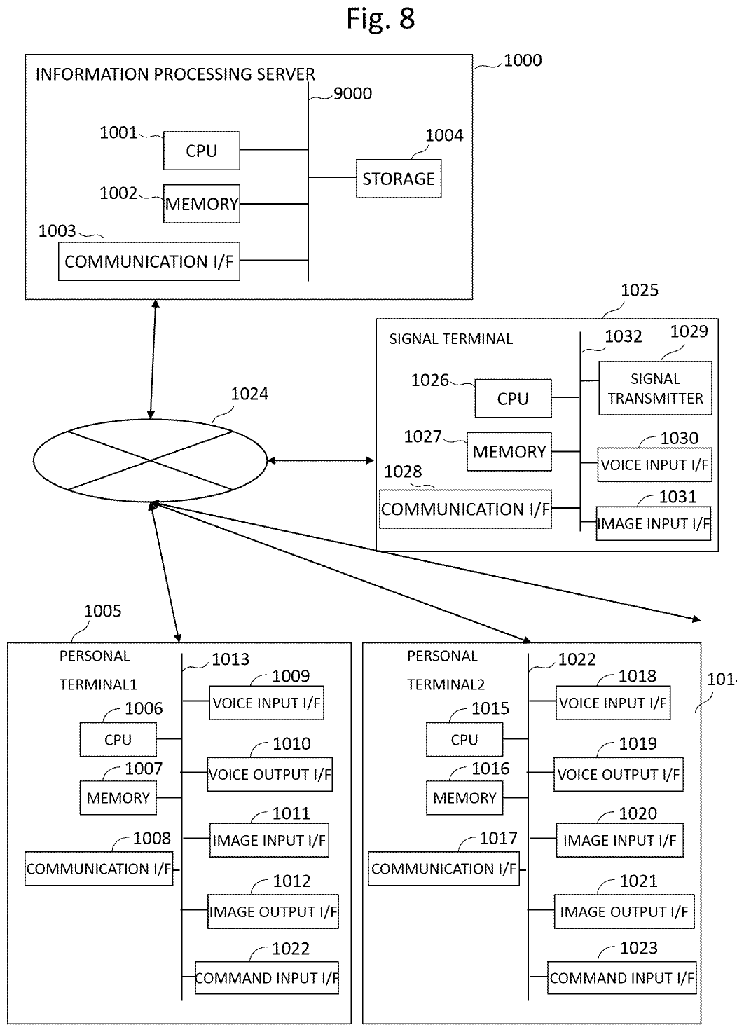

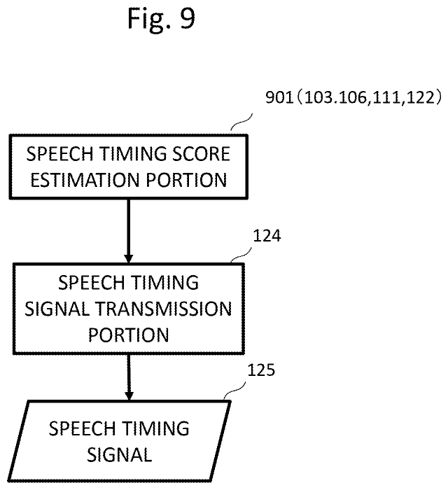

Hereafter, with reference to FIG. 8 and FIG. 9, a configuration and operation of a conference assistance device of this embodiment are explained. FIG. 8 is a block diagram showing an example of a hardware configuration of the conference assistance device in this embodiment. FIG. 9 is a block diagram showing an example of operation of the conference assistance device in this embodiment.

FIG. 8 shows an example of the hardware configuration of this embodiment. In the configuration of FIG. 8, one information processing server 1000 is connected to multiple personal terminals 1005, 1014 and to a signal terminal 1025 via the network 1024. The information processing server 1000 has the CPU 1001, memory 1002, communication I/F 1003, and storage 1004. These components are connected to each other by the bus 9000. The personal terminal 1005 includes the CPU 1006, memory 1007, communication I/F 1008, voice input I/F 1009, voice output I/F 1010, image input I/F 1011, and image output I/F 1012. These components are connected to each other by the bus 1013. The personal terminal 1014 includes the CPU 1015, memory 1016, communication I/F 1017, voice input I/F 1018, voice output I/F 1019, image input I/F 1020, and image output I/F 1021. These components are connected to each other by the bus 1022. The signal terminal 1025 has a CPU 1026, a memory 1027, a communication I/F 1028, a signal transmitter 1029, a voice input I/F 1030, and an image input I/F 1031. These components are connected to each other by a bus 1032. The information processing server 1000 may be absent. Multiple information processing server 1000 may be present. The signal terminal may be absent. The signal terminal may be incorporated in the information processing server.

FIG. 9 illustrates an example of processing in the memory 1002 in information processing server 1000, in the memory 1007 in the personal terminal 1005 and the memory 1016 in the personal terminal 1014, or in the memory 1027 in the signal terminal 1025 in FIG. 8 in this embodiment. This flow includes a speech timing score estimation portion 901 and a speech timing signal transmission portion 124. The speech timing score estimation portion 901 may use any of the speech timing score estimation portions 103, 106, 111, and 122 explained in the first to fourth embodiments.

The speech timing score outputted from the speech timing score estimation portion 901 is inputted into the speech timing signal transmission portion 124. The speech timing signal transmission portion 124 outputs a speech timing signal 125 when the inputted speech timing score is a fixed threshold or less. The timing signal is indicated to conference participants by the signal transmitter 1029, the voice output I/Fs 1010, 1019, or the image output I/Fs 1012, 1021 in FIG. 8.

As above, in this embodiment, without indicating a speech timing score of each conference participant, when speech timing scores of all participants (or a predetermined percentage of participants) are a predetermined threshold or less, the signal that “any participants now have an appropriate speech timing” is indicated to an unspecified number of the participants. This embodiment is effective in a simply configured conference assist system.

### Sixth Embodiment

The sixth embodiment assumes that not only a conference but also in a conversation among multiple persons includes a device that enables participants to automatically speak. The automatic speech device is called a speech robot. The speech timing score explained in the first to fourth embodiments is calculated for the speech robot to facilitate or suppress the speech of the speech robot.

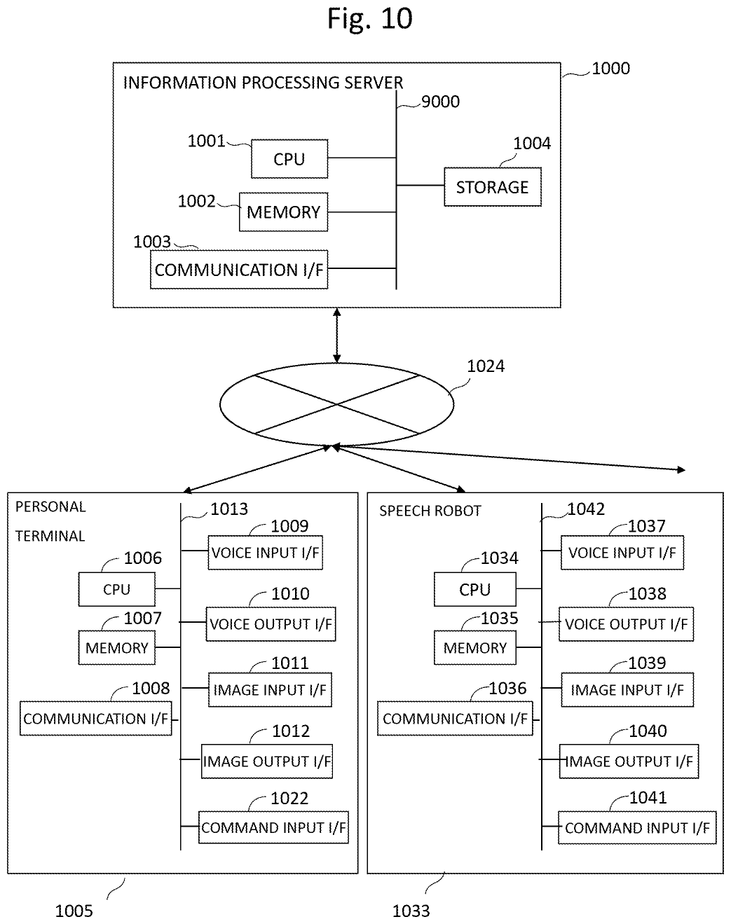

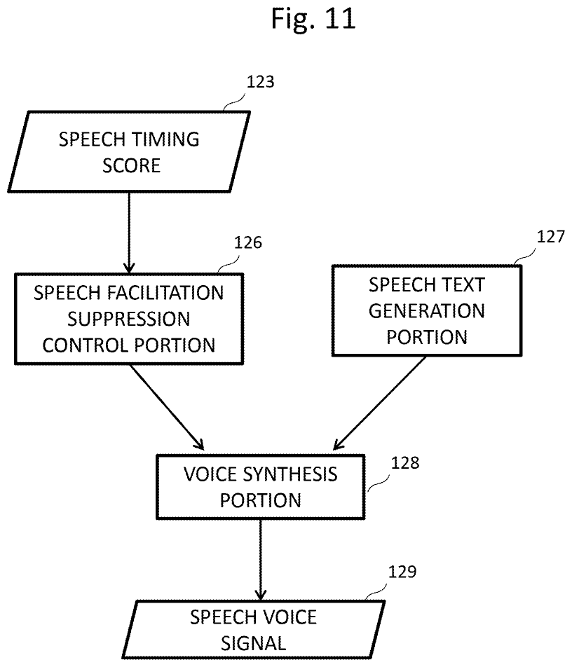

Hereafter, with reference to FIG. 10 and FIG. 11, a configuration and operation of a conference assistance device of this embodiment are explained. FIG. 10 is a block diagram showing an example of a hardware configuration of the conference assistance device in this embodiment. FIG. 11 is a block diagram showing an example of operation of the conference assistance device in this embodiment.

FIG. 10 illustrates an example of a hardware configuration of this embodiment. In the configuration of FIG. 10, one information processing server 1000 is connected to the personal terminal 1005 and speech robot 1033 via the network 1024. The information processing server 1000 has the CPU 1001, memory 1002, communication I/F 1003, and storage 1004. These components are connected to each other by the bus 9000. The personal terminal 1005 has the CPU 1006, memory 1007, communication I/F 1008, voice input I/F 1009, voice output I/F 1010, image input I/F 1011, and image output I/F 1012. These components are connected to each other by the bus 1013. The speech robot 1033 has a CPU 1034, a memory 1035, a communication I/F 1036, a voice input I/F 1037, a voice output I/F 1038, an image input I/F 1039, an image output I/F 1040, and a command input I/F 1041. These components are connected to each other by a bus 1042. The information processing server 1000 and personal terminal 1005 may be absent. Multiple information processing servers 1000 and multiple personal terminals 1005 may be present. Multiple speech robots 1033 may be present.

FIG. 11 illustrates an example of processing in the memory 1002 in the information processing server 1000, in the memory 1007 in the personal terminal 1005, or in the memory 1035 in the speech robot 1033 in FIG. 10 in this embodiment. A speech timing score 123 is inputted into a speech facilitation suppression control portion 126. The speech timing score 123 is calculated through any one of the methods in the first to fourth embodiments.

The speech facilitation suppression control portion 126 determines whether to facilitate or suppress a speech of the robot based on the inputted speech timing score 123 to output a speech facilitation suppression coefficient. As a method of determining the speech facilitation suppression coefficient, a threshold for a speech timing score is provided. When the speech timing score is the threshold or more, the coefficient indicates facilitation. When the speech timing score is the threshold or less, the coefficient indicates suppression. The speech timing score may be multiplied by any coefficients to determine speech facilitation suppression coefficients of successive values.

The speech facilitation suppression coefficient may be defined through any procedures. The speech facilitation suppression coefficient herein is a value between zero and one. As the value is low, a speech is suppressed. As the value is high, a speech is facilitated. A speech text generation portion 127 generates and outputs a speech text of the speech robot through a known rule based or machine learning technique. The speech facilitation suppression coefficient outputted from the speech facilitation suppression control portion 126 and the speech text outputted from the speech text generation portion 127 are inputted into a speech synthesis portion 128. Based on the inputted value of the speech facilitation suppression coefficient, the speech synthesis portion 128 determines whether to synthesize a speech voice signal based on the inputted speech text. Upon determining to synthesize the speech voice signal, the speech synthesis portion 128 synthesizes a speech voice signal 129. The synthesis may be determined through a method using a threshold provided to a speech timing score per each speech or through a combination of this method and another known method. The outputted speech voice signal 129 is converted to a speech waveform in the voice output I/F 1038 in the speech robot 1033 in FIG. 10, and outputted.

According to this embodiment, speech opportunities for participants can be actively indicated during a conference as a score for a system to recommend a speech. The indication is possible using numeral values, a time series graph, or lighting of a signal when the score is lower or higher than a threshold. The score may be indicated to all participants or to a specific participant such as a chairperson. A participant who sees the score can numerically recognize that the participant can easily speak, is expected to speak, or can provide a meaningful speech.

What is claimed is:

1. A conference assistance system that indicates a score to recommend a speech of a participant in a conference based on information inputted via an interface.

2. The conference assistance system according to claim 1 comprising:
an interface to input at least one of a voice or an image of a current speaker; and
a first speech timing score estimation portion that estimates a score to recommend a speech based on at least one of a voice or an image of the current speaker.

3. The conference assistance system according to claim 2 comprising an alertness estimation portion that estimates alertness of a current speaker based on at least a voice or an image of the current speaker,
wherein the first speech timing score estimation portion determines a score to recommend a speech based on the alertness.

4. The conference assistance system according to claim 1 comprising:
an interface to input speech recommendations from other participants; and
a second speech timing score estimation portion that determines a score to recommend a speech based on the speech recommendations from the other participants.

5. The conference assistance system according to claim 4,
wherein the second speech timing score estimation portion determines a score to recommend a speech based on a total of the speech recommendations from the other participants, and
each value of the recommendations from other participants decreases as time elapses since each speech recommendation is made.

6. The conference assistance system according to claim 1 comprising:
an interface to input a voice or a text of a current speaker and a voice or a text of a past speech of a score calculation subject; and
a third speech timing score estimation portion that determines a score to recommend a speech based on a relationship between a speech content of a current speaker and a past speech of a score calculation subject.

7. The conference assistance system according to claim 1 comprising at least any one of:
a first speech timing score estimation portion that estimates a first score to recommend a speech based on at least one of a voice and an image of a current speaker;
a second speech timing score estimation portion that determines a second score to recommend a speech based on speech recommendations from other participants; and
a third speech timing score estimation portion that determines a third score to recommend a speech based on a relationship between a speech content of a current speaker and a past speech of a score calculation subject.

8. The conference assistance system according to claim 7, wherein at least any one of the first score, the second score, and the third score is weighted to determine a total speech timing score based on the first score, the second score, and the third score.

9. The conference assistance system according to claim 1, wherein when the scores of all participants in a conference are a threshold or less, a signal is generated to recommend speeches of an unspecified number of the participants.

10. The conference assistance system according to claim 1, wherein a score to recommend a speech is used as a speech control parameter of a speech robot.

11. The conference assistance system according to claim 1, wherein an indication of a score to recommend a speech includes at least any one of an indication using a numeral value, an indication using a time series graph, and a lighting of a signal when the score is a threshold or more or less.

12. A method of assisting a conference, comprising calculating a score to recommend a speech to participants in a conference based on information inputted from an interface.

13. The method according to claim 12, comprising:
inputting at least any one of a voice and an image of a current speaker;
estimating alertness of the current speaker based on at least any one of a voice and an image of the current speaker; and
estimating a first timing score based on the alertness.

14. The method according to claim 12, comprising the steps of:
inputting speech recommendations from other participants; and
estimating a second score based on a total of the speech recommendations from the other participants,
wherein each of values of the speech recommendations from the other participants decreases as time elapses since each speech recommendation is made.

15. The method according to claim 12, comprising:
inputting a text of a speech content of a current speaker and a text of a past speech of a score calculation subject; and
estimating a third timing score based on a relationship between the speech content of the current speaker and the past speech of the score calculation subject.
